(19) United States
(12) Patent Application Publication
(10) Pub. No.: US 2013/0209642 A1
(43) Pub. Date: Aug. 15, 2013

(54) OIL COMPOUND AND METHOD FOR MAKING THE SAME

(71) Applicants: Adriana Fernanda Cruz Serna, Bogota (CO); Carlos Andrés Alvarez Sierra, Bogota (CO)

(72) Inventors: Adriana Fernanda Cruz Serna, Bogota (CO); Carlos Andrés Alvarez Sierra, Bogota (CO)

(73) Assignee: Team Foods Colombia S.A., Inc.

(21) Appl. No.: 13/520,170

(22) PCT Filed: Dec. 29, 2009
(86) PCT No.: PCT/IB2009/007910

§ 371 Date: Nov. 16, 2012

(51) Int. Cl. C11B 5/00

(52) U.S. Cl. CPC C11B 5/0092
USPC 426/542; 426/438

(57) ABSTRACT

An oil compound with a lower tendency to darken during frying operations, which has a concentration of polyphenolic compounds between 0.1 to 16 mg/Kg of product, a free acidity value between 0.001 and 0.1%, and a red color in the Lovibond scale of between 0.2 and 3.2.

### CROSS-REFERENCE TO RELATED APPLICATIONS

This application is a U.S. National Phase application of International Patent Application No. PCT/IB2009/007910, titled “Composition Comprising Oils with less Tendency to Darken for use in Industrial Frying and Production Method Thereof.” International Patent Application No. PCT/IB2009/007910 was filed on Dec. 12, 2009, and was not published in English. The disclosure of International Patent Application No. PCT/IB2009/007910 is hereby incorporated by reference in its entirety for all purposes.

### COPYRIGHT NOTIFICATION

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### BACKGROUND OF THE INVENTION

1. Field of the Invention

The present invention relates to an oil compound that can be used for frying processes, and in particular, to an oil compound with an improved color stability during frying processes, where the oil may be subjected to high temperatures.

2. Description of the Related Art

The degradation of vegetable oils subjected to high temperatures in frying processes may be due to oxidation and hydrolysis reactions, the humidity of the food products being fried, or residual particles. In the case of palm oil, there is a darkening of this type of vegetable oil in deep frying operation given its high content of minor compounds of the β-carotene type and other minor compounds of polyphenolic origin. This darkening is generally negatively perceived by consumers.

Known palm oil refining methods leave small quantities of these minor compounds that affect its performance when the palm oil is subjected to extreme conditions, such as high temperature frying operations. Among various vegetable oils used in deep frying operations, conventional palm oil has a faster darkening in comparison with other oils, such as sunflower, canola, and soy oil, among others.

Accordingly, there is a need for a more stable vegetable oil compounds for frying applications, and, in particular, a palm oil with a lower tendency to darken and a process to produce it.

### SUMMARY OF THE INVENTION

The present invention relates to an oil compound for frying applications, and in particular, a palm oil and/or its possible fractions, subjected to an refining process to remove unsaponifiable minor compounds to obtain an oil compound with better color stability and a smaller amount of polyphenolic compounds.

Additional goals and advantages of the present invention will become more evident in the description of the figures, the detailed description of the invention, and the claims.

The foregoing and/or other aspects and utilities of the present invention may be achieved by providing an oil compound, including a concentration of polyphenolic compounds between 0.1 to 16 mg/Kg, a free acidity value between 0.001 and 0.1%, a red color in the Lovibond scale between 0.2 and 3.2, and an antioxidant.

In another embodiment, the concentration of polyphenolic compounds is one of between 0.5 and 14 mg/Kg and between 1 and 12 mg/Kg.

In another embodiment, the free acidity value is one of between 0.005 and 0.07% and between 0.01 and 0.045%.

In another embodiment, the red color in the Lovibond scale is one of between 0.5 and 3.1 and between 0.8 and 3.0.

In another embodiment, the antioxidant is at least one of BHT (butylhydroxytoluene), TBHQ (tert-butylhydroquinone), BHA (butylhydroxyanisole), ascorbyl palmitate, propylgalate, mixtures of tocopherols, and citric acid.

In another embodiment, the antioxidant is one of BHT (butylhydroxytoluene), TBHQ (tert-butylhydroquinone), and citric acid.

In another embodiment, the antioxidant is TBHQ (tert-butylhydroquinone).

In another embodiment, the antioxidant is one of between 30 and 150 ppm, between 50 and 130 ppm, and between 80 and 120 ppm of the oil compound.

In another embodiment, the oil compound includes at least one of palm oil and/or its fractions, sunflower oil, high oleic sunflower oil, canola oil, safflower oil, high oleic safflower oil, cottonseed oil, and palm kernel oil.

The foregoing and/or other aspects and utilities of the present invention may also be achieved by providing an oil compound including a concentration of polyphenolic compounds between 0.1 to 16 mg/Kg, a free acidity value between 0.001 and 0.1%, a red color in the Lovibond scale ranging 0.2 and 3.2, and an antioxidant.

In another embodiment, the concentration of polyphenolic compounds is one of between 0.5 and 14 mg/Kg and 1 and 12 mg/Kg.

In another embodiment, the free acidity value is one of between 0.005 and 0.07% and between 0.01 and 0.045%.

In another embodiment, the red color on the Lovibond scale is one of between 0.5 and 3.1 and between 0.8 and 3.0.

In another embodiment, the antioxidants is one of BHT (butylhydroxytoluene), TBHQ (tert-butylhydroquinone), BHA (butylhydroxyanisole), ascorbyl palmitate, propylgalate, mixtures of tocopherols, and citric acid.

In another embodiment, the antioxidant is one of BHT (butylhydroxytoluene), TBHQ (tert-butylhydroquinonej, and citric acid.

In another embodiment, the antioxidant is TBHQ (tert-butylhydroquinone).

In another embodiment, the antioxidant is one of between 30 and 150 ppm, between 50 and 130 ppm, and between 80 and 120 ppm of the oil compound.

In another embodiment, the oil compound includes at least one of palm oil and/or its fractions, sunflower oil, high oleic sunflower oil, canola oil, safflower oil, high oleic safflower oil, cottonseed oil and palm kernel oil.

In another embodiment, the oil compound includes palm oil and its fractions, and, when the oil compound is heated to 180° C. and subjected to five 4.5-minute frying cycles of 1 kg of frozen French fries, the red color on the Lovibond scale of the oil compound is less than 4.

The foregoing and/or other aspects and utilities of the present invention may also be achieved a process to refine an oil compound including: degumming an oil compound by addition of citric acid in a proportion of 0.2% to 0.7%, at a temperature between 60 and 90° C., for a period of 5 to 20 minutes, at atmospheric pressure, bleaching of the degummed oil compound at a temperature between 85 and 95° C., for a period between 20 and 40 minutes, an agitation speed between 150 and 220 rpm, and a vacuum pressure between 10 and 50 hPa, by addition of adsorbent active natural clays and activated carbon in a mutual proportion of 1/1 to 3/1, respectively, and corresponding to a percentage of 0.1% to 1.5% in the oil compound, filtration the bleached and degummed oil compound to remove the clays, deodorization the bleached, degummed, and filtered oil compound with superheated steam stripping at a temperature between 235 and 265° C. for a period between 45 and 90 minutes with a vacuum pressure of 2 to 5 hPa and an injection of vapor of 0.5 to 3%; and adding 30 to 150 ppm of antioxidants at a temperature between 55 and 70° C. at atmospheric pressure.

In another embodiment, the bleaching of the oil compound further includes a previous addition of a silica gel in an amount equal to between 0.05% and 0.2% of a weight of the oil compound at a temperature between 85 and 95° C. for a period between 20 and 40 minutes, an agitation speed between 150 and 220 rpm, and a vacuum pressure between 10 and 50 hPa.

In another embodiment, the degumming of the oil compound further includes neutralization with a caustic soda solution of 15° Be in a proportion of 5% to 35% of an amount calculated to be neutralized according to the free acidity of oil compound, and drying the oil compound at a temperature between 80 and 95° C. for a period between 1 and 20 minutes with a vacuum pressure between 10 and 50 hPa.

In another embodiment, the clays are at least one of hormite and smectite.

In another embodiment, after the addition of the antioxidants, the oil compound has a red color in the Lovibond scale ranging between 0.2 and 3.2, and, when the oil compound is heated to 180° C. and subjected to five 4.5-minute frying cycles of 1 kg of frozen French fries, the red color on the Lovibond scale of the oil compound is less than 4.

The foregoing and/or other aspects and utilities of the present invention may also be achieved by a process of frying food products, including using an oil compound as a frying medium, wherein the oil compound includes a free acidity value between 0.001 and 0.1%, a red color in the Lovibond scale ranging 0.2 and 3.2, and an antioxidant, and wherein the red color on the Lovibond scale of the oil compound is less than 4 after being heated to 180° C. and subjected to five 4.5-minute frying cycles of the food product.

In another embodiment, the food product includes frozen potato French fries.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1. illustrates the effects of polyphenolic compounds on color stability of oil compounds when subjected to frying temperatures of about 180° C.

FIG. 2. illustrates a change in red color, under the Lovibond scale, of oil compounds refined under embodiments of the present invention and refined conventionally.

The drawings above are not necessarily to scale, with emphasis instead generally being placed upon illustrating the principles of the present invention. Further, some features may be exaggerated to show details of particular components. These drawings/figures are intended to be explanatory and not restrictive regarding this invention.

### DETAILED DESCRIPTION OF THE EMBODIMENTS

Reference will now be made in detail to the various embodiments of the present invention. The embodiments are described below to provide a more complete understanding of the components, processes and apparatuses of the present invention. Any examples given are intended to be illustrative, and not restrictive. Throughout the specification and claims, the following terms take the meanings explicitly associated herein, unless the context clearly dictates otherwise. The phrases “in some embodiments” and “in an embodiment” as used herein do not necessarily refer to the same embodiment(s), though they may. Furthermore, the phrases “in another embodiment” and “in some other embodiments” as used herein do not necessarily refer to a different embodiment, although they may. As described below, various embodiments of the present invention may be readily combined, without departing from the scope or spirit of the present invention.

As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

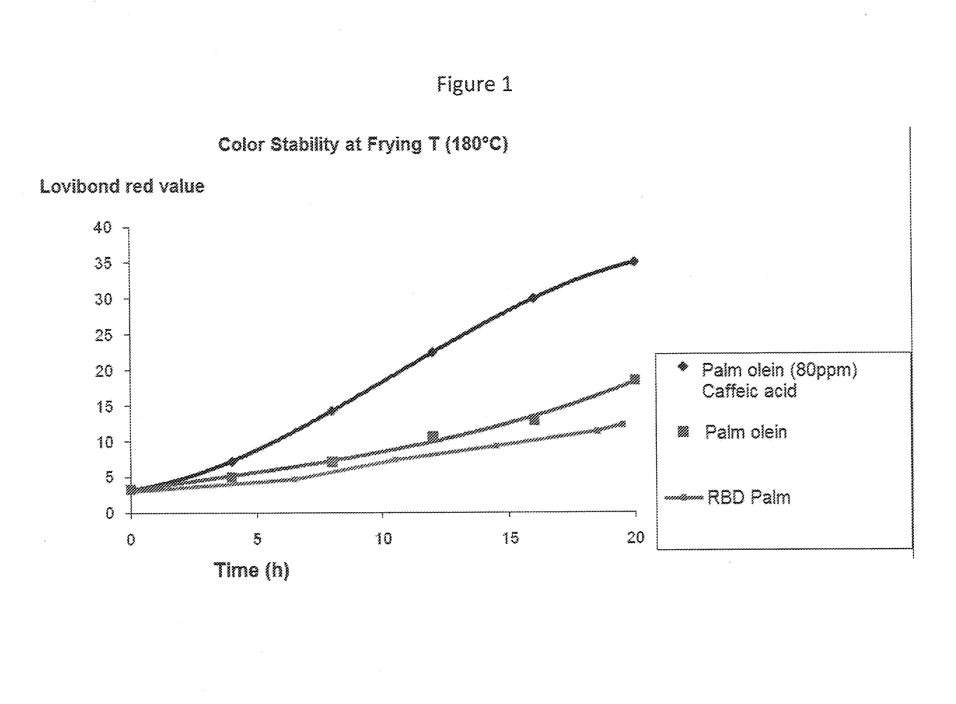

FIG. 1 illustrates the darkening effects of polyphenolic compounds. As illustrated in FIG. 1, color stability samples were taken from RDB palm oil, palm oil olein, and palm oil olein with 80 ppm of caffeic acid (a polyphenolic compound) added. These oils were subjected for 20 hours to temperatures similar to those of frying operations, evaluating the red color parameters on the Lovibond scale in order to determine their influence (method AOCS Cc 13b-45) on this characteristic. The red color parameters can be determined, for example, using American Oil Chemists' Society (AOCS) method Cc 13b-45. FIG. 1 illustrates the relationship of polyphenolic compounds, such as caffeic acid, to the color of the oil at frying temperatures for RDB palm oil and refined palm olein. As illustrated in FIG. 1, the Lovibond red value was highest for the palm oil olein with 80 ppm of caffeic acid added.

One embodiment of the present invention provides an oil with better color stability and greater resistance to darkening in frying operations through a new refining process to remove minor compounds, especially those of polyphenolic origin, from the oil.

Another embodiment of the present invention provides a refining process that combines both chemical and physical treatments with certain agents and certain proportions to yield an oil compound with better performance with regard to color stability in frying operations.

Table 1 illustrates an efficiency of polyphenolic compounds removal under embodiments of the present invention. The removal efficiency of polyphenolic compounds can be determined, for example using the Folin-Ciocalteu Method. As illustrated in Table 1, removal efficiency of polyphenolic compounds from oil compounds, such as palm oils and/or their fractions, is 80% or higher when refined under embodiments of the present invention, in contrast to a conventional refining method with a removal efficiency below 70%.

TABLE 1

| | Palm oil | Palm oil Invention | Palm oil standard |
|---|---|---|---|
| | Invention Data 1 | Data 2 | method |
| Efficiency of | 90.30% | 81.90% | 66.08% |
| Removal | | | |

In one embodiment of the present invention, the process to obtain an oil compound with a smaller amount of polyphenolic compounds and a lower tendency to darken includes:

Degumming of the oil compound by the addition of citric acid in a proportion of 0.2 to 0.7%, at a temperature between 60° C. and 90° C., and for a period of 5 to 20 minutes at atmospheric pressure. In an embodiment of the present invention, and according to the quality of the oil (measured in terms of free acidity expressed as % oleic acid), the degumming operation may include an additional neutralizing operation with caustic soda of 15° Be in a proportion of 5% to 35% of the amount calculated to be neutralized according to the free acidity of the crude oil expressed as a percentage of oleic acid, followed by a drying phase at a temperature between 80° C. and 95° C. for a period between 1 and 20 minutes with a vacuum pressure between 10 and 50 hPa.

In one embodiment of the invention, the degummed oil compound is then subject to a bleaching phase conducted at a temperature between 85° C. and 95° C. for a period between 20 and 40 minutes, an agitation speed between 150 and 220 rpm, and a vacuum pressure between 10 and 50 hPa. In one embodiment, the bleaching phase includes the addition of adsorbent active natural clays of mineral origin, such as hormite and smectite, and activated carbon in a mutual proportion of 1/1 to 3/1, respectively, and corresponding to a percentage of 0.1% to 1.5% in the oil. In one embodiment, the bleaching phase may also include a previous addition of a silica gel in a range between 0.05% and 0.2% of the weight of the oil at a temperature between 85° C. and 95° C. for a period between 20 and 40 minutes, an agitation speed between 150 and 220 rpm and a vacuum pressure between 10 and 50 hPa. In an embodiment of the present invention, the bleaching phase may conclude with a filtration process for the removal of the clays.

In one embodiment of the invention, the degummed and bleached oil compound is then subject to a deodorization phase. In an embodiment, the deodorization phase includes superheated steam stripping at a temperature between 235 and 265° C. for a period between 45 and 90 minutes with a vacuum pressure of 2 to 5 hPa and an injection of vapor of 0.5 to 3%. In one embodiment, the deodorization phase also includes adding a quantity between 30 and 150 ppm of antioxidants, such as BHT (butylhydroxytoluene), TBHQ (tert-butylhydroquinone), BHA (butylhydroxyanisole), ascorbyl palmitate, propylgalate, mixtures of tocopherols and/or citric acid, at the end of the deodorization stage, in the discharge, at a temperature between 55° C. and 70° C. and at atmospheric pressure.

In an embodiment of the present invention, the oil compound can be a vegetable oil, such as sunflower oil, high oleic sunflower oil, canola oil, safflower oil, high oleic safflower oil, cottonseed oil, palm kernel oil and palm oil and/or its fractions. In an embodiment of the present invention, a concentration of polyphenolic compounds is in a range of 0.1 to 16 mg/Kg of product. In another embodiment of the present invention, the concentration of polyphenolic compounds, is between 0.5 and 14 mg/Kg of product or between 1 and 12 mg/Kg.

In an embodiment of the present invention, a free acidity value of the oil compound, expressed as % oleic acid, is between 0.001% and 0.1%. In another embodiment of the present invention, the free acidity values is between 0.005% and 0.07% or between 0.01% and 0.045%. In an embodiment of the present invention, a red color of the oil compound on the Lovibond scale is between 0.2 and 3.2. In another embodiment of the present invention, the red color of the oil compound on the Lovibond scale is between 0.5 and 3.1 or between 0.8 and 3.0.

In an embodiment of the present invention, the oil compound can be a vegetable oil, such as sunflower oil, high oleic sunflower oil, canola oil, safflower oil, high oleic safflower oil, cottonseed oil, palm kernel oil and palm oil and/or its fractions, and a polyphenol content is between 0.1 and 16 mg/Kg of product, or between 0.5 and 14 mg/Kg of product, a free acidity value, expressed as % of oleic acid, is between 0.001 and 0.1%, or between 0.005 and 0.07%, and a red color in the Lovibond scale is between 0.2 and 3.2 or between 0.5 and 3.1. In another embodiment of the present invention, the polyphenol content is between 1 and 12 mg/Kg, a free acidity value is between 0.01 and 0.045%, and a red color in the Lovibond scale is between 0.8 and 3.0.

Oil compounds obtained through embodiments of the present invention have improved red color stability, as measured on the Lovibond scale, and less darkening tendencies during frying operations in comparison with oils obtained through conventional refining methods. Conventionally refined oils, especially those originating from palm oil, are often discarded more rapidly because of this characteristic darkening, which is unpleasant to the user, and making these oils less efficient for these types of applications.

### Example 1

In one embodiment of the invention, an oil composition with a lower amount of polyphenol content was produced using the following method.

For example, different samples of crude palm oil were taken (18 kg per trial) with an initial acidity of 2.86% and refined according to embodiments of the present invention as illustrated in Table 2 below.

TABLE 2
(Conditions 1)

| | | Tem- | | Vacuum | Agitation |
|---|---|---|---|---|---|
| SAMPLE 2 | % Material | perature | Time | pressure | speed |
| DEGUMMING | 0.5% citric acid | 80° C. | 10 min | atmos- | 180 rpm |
| | | | | pheric | |
| NEUTRAL- | Soda 15°Be, | 80° C. | 15 min | atmos- | 180 rpm |
| IZATION | 82.51 gr | | | pheric | |
| BLEACHING | Silica 0.15% | 90° C. | 20 min | 20 hPa | 180 rpm |
| | Activated | 95° C. | 30 min | 20 hPa | 180 rpm |
| | carbon 0.4%/ | | | | |
| | bleaching clay, | | | | |
| | 1% | | | | |
| DEODOR- | 1% superheated | 250° C. | 60 min | 3 hPa | n/a |
| IZATION | vapor | | | | |

n/a = not applicable

TABLE 3
(Conditions 2)

| | | Tem- | | Vacuum | Agitation |
|---|---|---|---|---|---|
| SAMPLE 3 | % Material | perature | Time | pressure | speed |
| DEGUMMING | 0.5% citric acid | 80° C. | 10 min | atmos- | 180 rpm |
| | | | | pheric | |
| BLEACHING | Activated | 95° C. | 30 min | 20 hPa | 180 rpm |
| | carbon 0.5%/ | | | | |
| | bleaching | | | | |
| | clay, 1% | | | | |
| DEODOR- | 1% superheated | 250° C. | 60 min | 3 hPa | n/a |
| IZATION | vapor | | | | |

n/a = not applicable

The total content of polyphenolic compounds, free acidity, and red color stability, as measured on the Lovibond scale, was measured and compared to an oil compound refined in a conventional manner. Table 4 illustrates the results obtained.

TABLE 4

| | Sample 2 | Sample 3 | Conventional |
|---|---|---|---|
| | (Conditions 1) | (Conditions 2) | Palm Oil |
| Initial concentration of | 56.198 | 56.198 | 56.198 |
| polyphenols | | | |
| Final concentration of | 5.45 | 10.17 | 19.06 |
| polyphenols | | | |
| Lovibond color, red | 3 | 2.7 | 3.3 |
| Free acidity, FFA | 0.042 | 0.029 | 0.045 |
| (oleic %) | | | |

As illustrated in Table 4, oil compounds refined under embodiments of the present invention have a lower final content of polyphenolic compounds as compared to the standard procedure.

### Example 2

In another embodiment of the present invention, oil compositions refined under embodiments of the present invention were subjected to deep frying processes to measure their performance.

For example, the refined oil compound of Example 1 (Sample 2 and Sample 3) were used to deep fry pre-cooked French fries in order to examine their performance and color stability as compared to conventionally refined oil. To this end, the oils were heated to 180° C. and 5 frying cycles of 1 kg of potatoes were conducted for 4.5 minutes per cycle with each type of oil, in order to measure the various variables of free acidity, peroxides and polar compounds, as well as measurement of the Lovibond red color per cycle to determine the degree of stability.

Table 5 illustrates the results of Sample 2 (Conditions 1) during the frying operations; Table 6 illustrates the results for Sample 3 (Conditions 2); and Table 7 illustrates the results for conventionally refined oil.

TABLE 5
Results of the frying tests for Conditions 1

| | LOVIBOND | | | |
|---|---|---|---|---|
| SAMPLE 2 | SCALE | | | POLAR |
| (Conditions | RED | PEROXIDES | ACIDITY | COMPOUNDS |
| 1) | COLOR | (mg/kg oil) | (oleic %) | (%) |
| Initial | 3 | 1.008 | 0.0423 | 2 |
| conditions | | | | |
| cycle 1 | 3.2 | 1.02 | 0.0436 | 3.5 |
| cycle 2 | 3.3 | 1.067 | 0.052 | 5 |
| cycle 3 | 3.4 | 1.112 | 0.0557 | 5.5 |
| cycle 4 | 3.8 | 1.332 | 0.0771 | 6 |
| cycle 5 | 3.9 | 2.425 | 0.0795 | 8 |

TABLE 6
Results of the frying tests for Conditions 2

| | LOVIBOND | | | |
|---|---|---|---|---|
| SAMPLE 3 | SCALE | | | POLAR |
| (Conditions | RED | PEROXIDES | ACIDITY | COMPOUNDS |
| 2) | COLOR | (mg/kg oil) | (oleic %) | (%) |
| Initial | 2.7 | 2.169 | 0.0294 | 1 |
| conditions | | | | |
| cycle 1 | 2.9 | 2.635 | 0.0362 | 3 |
| cycle 2 | 3.1 | 2.79 | 0.0463 | 3.5 |
| cycle 3 | 3.1 | 3.549 | 0.0483 | 4 |
| cycle 4 | 3.2 | 3.647 | 0.0558 | 4.5 |
| cycle 5 | 3.4 | 4.349 | 0.0569 | 5 |

TABLE 7
Results of the frying tests for conventionally refined oil

| | LOVIBOND | | | |
|---|---|---|---|---|
| Conventional | SCALE | | | POLAR |
| Palm | RED | PEROXIDES | ACIDITY | COMPOUNDS |
| Oil | COLOR | (mg/kg oil) | (oleic %) | (%) |
| Initial- | 3.3 | 0.903 | 0.045 | 1.5 |
| standard oil | | | | |
| cycle 1 | 3.9 | 0.976 | 0.0498 | 3 |
| cycle 2 | 4 | 1.879 | 0.0516 | 6 |
| cycle 3 | 4.2 | 4.224 | 0.0621 | 8 |
| cycle 4 | 4.3 | 5.917 | 0.0908 | 8.5 |
| cycle 5- | 5.3 | 6.541 | 0.0973 | 9.5 |
| standard oil | | | | |

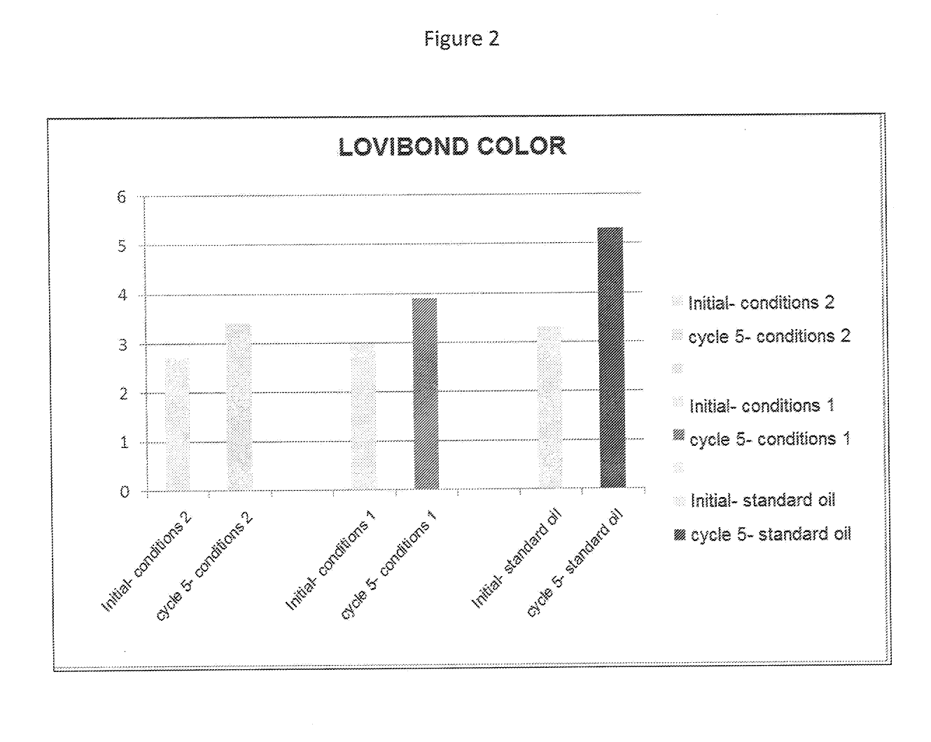

As illustrated in Tables 5-7, a clear improvement can be seen in the color of the oil after the 5 frying cycles for Sample 1 and Sample 2. The Lovibond scale red color of the final oil is much more stable for Samples 1 and 2 than for the conventional oil. The results of Tables 5-7 are summarized in FIG. 2.

In addition to the Lovibond red color parameter, Tables 5-7 illustrate a higher stability in the other physicochemical variables after 5 frying cycles, such as % of free acidity and the content of peroxides and other polar compounds which demonstrate an improved performance of the oil refined under embodiments of the present invention.

Although a few embodiments of the present invention have been shown and described, it will be appreciated by those skilled in the art that changes may be made in these embodiments without departing from the principles and spirit of the present invention, the scope of which is defined in the appended claims and their equivalents.

1. An oil compound, comprising:
a concentration of polyphenolic compounds between 0.1 to 16 mg/Kg;
a free acidity value between 0.001 and 0.1%;
a red color in the Lovibond scale between 0.2 and 3.2;
and an antioxidant.

2. The oil compound of claim 1, wherein the concentration of polyphenolic compounds is one of between 0.5 and 14 mg/Kg between 1 and 12 mg/Kg.

3. The oil compound of claim 1, wherein the free acidity value is one of between 0.005 and 0.07% and between 0.01 and 0.045%.

4. The oil compound of claim 1, wherein the red color in the Lovibond scale is one of between 0.5 and 3.1 and between 0.8 and 3.0.

5. The oil compound of claim 1, wherein the antioxidant is at least one of BHT (butylhydroxytoluene), TBHQ (tert-butylhydroquinone), BHA (butylhydroxyanisole), ascorbyl palmitate, propylgalate, mixtures of tocopherol, and citric acid.

6. The oil compound of claim 5, wherein the antioxidant is one of BHT (butylhydroxytoluene), TBHQ (tert-butylhydroquinone), and citric acid.

7. The oil compound of claim 6, wherein the antioxidant is TBHQ (tert-butylhydroquinone).

8. The oil compound of claim 7, wherein the antioxidant comprises one of between 30 and 150 ppm, between 50 and 130 ppm, and between 80 and 120 ppm of the oil compound.

9. The oil compound of claim 1, wherein the oil compound comprises at least one of palm oil and/or its fractions, sunflower oil, high oleic sunflower oil, canola oil, safflower oil, high oleic safflower oil, cottonseed oil, and palm kernel oil.

10. An oil compound comprising:
a concentration of polyphenolic compounds between 0.1 to 16 mg/Kg;
a free acidity value between 0.001 and 0.1%;
a red color in the Lovibond scale ranging 0.2 and 3.2;
and an antioxidant.

11. The oil compound of claim 10, wherein the concentration of polyphenolic compounds is one of between 0.5 and 14 mg/Kg and 1 and 12 mg/Kg.

12. The oil compound of claim 10, wherein the free acidity value is one of between 0.005 and 0.07% and between 0.01 and 0.045%.

13. The oil compound of claim 10, wherein the red color on the Lovibond scale is one of between 0.5 and 3.1 and between 0.8 and 3.0.

14. The oil compound of claim 10, wherein the antioxidants is one of BHT (butylhydroxytoluene), TBHQ (tert-butylhydroquinone), BHA (butylhydroxyanisole), ascorbyl palmitate, propylgalate, mixtures of tocopherols, and citric acid.

15. The oil compound of claim 14, wherein the antioxidant is one of BHT (butylhydroxytoluene), TBHQ (tert-butylhydroquinone), and citric acid.

16. The oil compound of claim 15, wherein the antioxidant is TBHQ (tert-butylhydroquinone).

17. The oil compound of claim 16, wherein the antioxidant comprises one of between 30 and 150 ppm, between 50 and 130 ppm, and between 80 and 120 ppm of the oil compound.

18. The oil compound of claim 17, wherein the oil compound comprises at least one of palm oil and/or its fractions, sunflower oil, high oleic sunflower oil, canola oil, safflower oil, high oleic safflower oil, cottonseed oil and palm kernel oil.

19. The oil compound of claim 18, wherein the oil compound comprises palm oil and its fractions and wherein, when the oil compound is heated to 180° C. and subjected to five 4.5-minute frying cycles of 1 kg of frozen French fries, the red color on the Lovibond scale of the oil compound is less than 4.

20. A process to refine an oil compound, comprising:
degumming an oil compound by addition of citric acid in a proportion of 0.2% to 0.7%, at a temperature between 60 and 90° C., for a period of 5 to 20 minutes, at atmospheric pressure;
bleaching of the degummed oil compound at a temperature between 85 and 95° C., for a period between 20 and 40 minutes, an agitation speed between 150 and 220 rpm, and a vacuum pressure between 10 and 50 hPa, by addition of adsorbent active natural clays and activated carbon in a mutual proportion of 1/1 to 3/1, respectively, and corresponding to a percentage of 0.1% to 1.5% in the oil compound,
filtration the bleached and degummed oil compound to remove the clays;
deodorization the bleached, degummed, and filtered oil compound with superheated steam stripping at a temperature between 235 and 265° C. for a period between 45 and 90 minutes with a vacuum pressure of 2 to 5 hPa and an injection of vapor of 0.5 to 3%; and
adding 30 to 150 ppm of antioxidants at a temperature between 55 and 70° C. at atmospheric pressure.

21. The process of claim 20, wherein the bleaching of the oil compound further comprises a previous addition of a silica gel in an amount equal to between 0.05% and 0.2% of a weight of the oil compound at a temperature between 85 and 95° C. for a period between 20 and 40 minutes, an agitation speed between 150 and 220 rpm, and a vacuum pressure between 10 and 50 hPa.

22. The process of claim 21, wherein the degumming of the oil compound further comprises:
neutralization with a caustic soda solution of 15° Be in a proportion of 5% to 35% of an amount calculated to be neutralized according to the free acidity of oil compound; and
drying the oil compound at a temperature between 80 and 95° C. for a period between 1 and 20 minutes with a vacuum pressure between 10 and 50 hPa.

23. The process of claim 20, wherein the clays are at least one of hormite and smectite.

24. The process of claim 20, wherein after the addition of the antioxidants, the oil compound has a red color in the Lovibond scale ranging between 0.2 and 3.2, and
wherein, when the oil compound is heated to 180° C. and subjected to five 4.5-minute frying cycles of 1 kg of frozen French fries, the red color on the Lovibond scale of the oil compound is less than 4.

25. A process of frying food products, comprising:
using and oil compound as a frying medium; wherein the oil compound comprises:
a free acidity value between 0.001 and 0.1%;
a red color in the Lovibond scale ranging 0.2 and 3.2;
and an antioxidant, and
wherein the red color on the Lovibond scale of the oil compound is less than 4 after being heated to 180° C. and subjected to five 4.5-minute frying cycles of the food product.

26. The process of claim 25, wherein the food product comprises frozen potato French fries.
